(19) United States
(12) Patent Application Publication
(10) Pub. No.: US 2019/0335543 A1
(43) Pub. Date: Oct. 31, 2019

(54) PTC HEATING MODULE

(71) Applicant: Mahle International GmbH, Stuttgart (DE)

(72) Inventors: Victor Caudy, Bouzonville (FR); Eric Marlier, Kolbsheim (FR); Rachid Safer, Maizieres-Les-Metz (FR); Falk Viehrig, Stuttgart (DE)

(21) Appl. No.: 16/396,250

(22) Filed: Apr. 26, 2019

(30) Foreign Application Priority Data
Apr. 27, 2018 (EP) 18169850.7

(51) Int. Cl. H05B 3/14; H05B 3/24

(52) U.S. Cl. CPC H05B 3/141; H05B 2203/02; H05B 3/24

(57) ABSTRACT

A PTC heating module may include at least one cuboid PTC thermistor element with two opposing main surfaces, which may be connected to one another via two opposing lateral surfaces. The PTC heating module may also include two contact elements each lying against one of the lateral surfaces and via which the PTC thermistor element may be electrically contactable, a housing in which the at PTC thermistor element and the contact elements may be arranged, and two insulating boards each lying against one of the main surfaces and electrically insulating the PTC thermistor element from the housing and connecting the PTC thermistor element to the housing in a heat-transferring manner. Each contact element may be electroconductively fixed on one side on one of the lateral surfaces and on another side on one of two contacting tracks, each of which may be arranged on one of the insulating boards.

### CROSS-REFERENCE TO RELATED APPLICATION

This application claims priority to European Patent Application No. 18169850.7, filed Apr. 27, 2018, which is hereby incorporated by reference in its entirety.

### TECHNICAL FIELD

The invention relates to a PTC heating module for heating a fluid. The invention also relates to a method for producing the PTC heating module.

### BACKGROUND

PTC heating modules (PTC: positive temperature coefficient) are already known from the prior art and can be used for heating a fluid such as for example air. A PTC heating module comprises one or more PTC elements which are produced from a PTC thermistor material with a temperature-dependent OHMIC resistance. When a voltage is applied, the resistance of the PTC element increases and the PTC element is heated. The heat generated in the PTC element can be passed on to the fluid to be heated.

Usually, the PTC elements are cuboid and have a thickness in the range of a few millimetres. Practically, the heat is passed on to the fluid on the larger main surfaces of the PTC element located opposite and the PTC element electrically contacted laterally. In order to electrically insulate the electrically contacted PTC elements to the outside, these are arranged between insulating boards lying against the main surfaces. The PTC elements with the adjacent insulating boards are arranged in a housing which, for the effective heat discharge to the fluid, are usually produced from metal.

The lateral contacting of the PTC elements in such a PTC element brings with it major technical expenditure. On the one hand, only a limited installation space for the contacting is available because of the small thickness of the respective PTC element and, on the other hand, the contacts have to be electrically insulated in addition. This results in an increase of the production effort and the production costs.

### SUMMARY

The object of the invention therefore is to state for a PTC heating module of the generic type an improved or at least alternative embodiment with which the described disadvantages are overcome. A further object of the invention is to provide a suitable method for producing the PTC heating module.

According to the invention, these objects are solved through the subject of the independent claims. Advantageous embodiments are subject of the dependent claims.

The present invention is based on the general idea of technically simplifying a contacting in a PTC heating module for heating a fluid. Here, the PTC heating module for heating a fluid comprises at least one cuboid PTC thermistor element. The PTC thermistor element has two main surfaces arranged located opposite one another, which are connected to one another via two lateral surfaces arranged located opposite one another. Here, the PTC thermistor element is electrically contactable to the outside on the respective lateral surface in each case via a contact element lying against the respective lateral surface. Furthermore, the PTC heating module comprises a housing in which the at least one PTC thermistor element and the respective contact elements are arranged. Here, an insulating plate each lies against the main surfaces of the PTC thermistor element in a heat-transferring manner, which electrically insulates the at least one PTC thermistor element from the housing and connects the same to the housing in a heat-transferring manner. According to the invention, the respective contact element is electroconductively fixed on the one side to a respective lateral surface of the at least one PTC thermistor element and on the other side to a contacting track. Here, the contacting track is arranged on one of the insulating boards.

By way of the contacting track arranged on one of the insulating boards the contacting of the at least one PTC thermistor element is significantly simplified. In particular, the respective contact element can be fixed on the insulating board even before the at least one PTC thermistor element is arranged. The contacting of the at least one PTC thermistor element usually involving major technical effort is, in this way, limited to fixing the respective contact element on the respective insulating board. Furthermore, the overall construction of the PTC heating module is significantly simplified through the contacting track on the respective insulating board and the respective contact element.

In the PTC heating module, the at least one PTC thermistor element is arranged between the insulating boards arranged on its main surfaces. The respective insulating boards are then arranged between the at least one PTC thermistor element and the housing and connect the at least one PTC thermistor element to the housing on the respective main surfaces in a heat-conducting manner. Furthermore, the respective insulating boards electrically insulate the at least one PTC thermistor element from the housing. Practically, the respective insulting boards lie against the main surfaces of the at least one PTC thermistor element with the full surface area in order to be able to electrically insulate the at least one PTC thermistor element from the housing also over the full surface area. Here, the heat exchange takes place on the main surfaces of the at least one PTC thermistor element via the insulating boards and the housing, so that the heat generated in the at least one PTC thermistor element is discharged to the fluid to be heated via the insulating boards and via the housing.

Advantageously, the respective contact element can lie against the contacting track and against the respective lateral surface with the full surface area in order to ensure the contacting of the at least one PTC thermistor element. In particular, the respective contact element can extend over the entire length of the respective lateral surface of the at least one PTC thermistor element. Because of this, the PTC heating module with a PTC thermistor element contacted in such a manner remains mechanically stable and securely contacted even with a greater heat expansion of the individual components in the PTC heating module. Practically, the respective contact element is produced from an electroconductive material. Advantageously, the at least one PTC thermistor element is electrically contactable by way of the one contact element to a negative terminal and via the other contact element to a positive terminal so that an external voltage can be applied to the at least one PTC thermistor element.

The PTC heating module can comprise multiple PTC thermistor elements which are arranged between the respective insulating boards. Alternatively, the PTC heating module can comprise multiple PTC thermistor elements which are each arranged between the respective insulating boards. The multiple PTC thermistor elements arranged between the respective insulating boards and the multiple PTC thermistor elements arranged in each case between the respective insulating boards are then arranged in the joint housing. The individual PTC thermistor elements in the PTC heating module are then electrically contactable to the outside jointly or individually via the respective contact elements and via the contacting track.

Advantageously it can be provided that the respective contacting track is formed by an electroconductive solder layer or by an electroconductive adhesive layer. By way of the electroconductive solder layer or by way of the electroconductive adhesive layer, the respective contact element is then soldered or glued to the respective insulating board. Alternatively it can be provided that the respective contacting track is formed by a conductor that is fixed to the respective insulating plate in a firmly bonded manner. Then, the respective contact element is fixed to the conductor in a firmly bonded manner, preferably by soldering or by gluing. The conductor can be soldered or glued to the respective insulating board. Advantageously it can be alternatively provided that the respective contacting track is formed by a circuit board with at least one conductor, wherein the circuit board is fixed to the insulating board and the respective contact element is fixed to the conductor on the circuit board in a firmly bonded manner preferably by soldering or by gluing. Here, the at least one conductor can be fixed to the circuit board in a firmly bonded manner, preferably by soldering or by gluing.

In a further development of the PTC heating module according to the invention it can be provided that the respective insulating board is ceramic. Here, the insulating board is arranged between the at least one PTC thermistor element and the housing and connects the at least one PTC thermistor element on the respective main surface to the housing in a heat-conducting manner. Furthermore, the respective insulating board electrically insulates the at least one PTC thermistor element from the housing. Here, the heat exchange takes place via the main surfaces of the at least one PTC thermistor element and the heat generated in the at least one PTC thermistor element is passed on to the fluid to be heated and surrounding the housing on the main surfaces by way of the respective insulating boards and via the housing.

Advantageously it can be provided that the respective contact element is formed by an S- or C- or L- or O-shaped resilient metal element. By its shape, the metal element can lie against the contacting track and against the respective lateral surface over a large surface area in order to ensure the contacting of the at least one PTC thermistor element. In addition, the metal element can have an elongated configuration as a result of which in particular the at least one PTC thermistor element can be contacted over the entire length of the respective lateral surface. The shape of the respective metal element in this case depends on the configuration of the contacting track. If the contacting track is the electroconductive solder layer or the electroconductive adhesive layer, a C- or O-shaped metal element is conceivable for example. If the contacting track is the conductor that is fixed to the respective insulating board in a firmly bonded manner or the circuit board with the at least one conductor, an S- or L-shaped metal element is conceivable for example. By its shape, the metal element makes possible a secure electrical contacting of the contacting track with the at least one PTC thermistor element in a reduced installation space that is limited by the thickness of the PTC thermistor element and lies in the range of a few millimetres. In particular because of this, the lateral contacting of the at least one PTC thermistor element that is usually technically involved can be significantly simplified.

In order to intensify the heat exchange between the PTC heating module and the fluid, the PTC heating module can comprise at least one rib structure. The rib structure then lies against the housing in a heat-transferring manner and is located opposite the respective main surfaces of the at least one PTC thermistor element. The rib structure enlarges a heat emitting surface of the housing that is in contact with the fluid, so that the heat exchange between the PTC heating module and the fluid to be heated is intensified. The rib structure is practically produced from a heat-conducting material, for example from a metal, preferably from aluminium and can be integrally formed or heat-transferringly fixed on the housing. Advantageously it can be provided that the housing is metallic, preferably consisting of aluminium. By way of the metallic housing, the heat exchange between the PTC heating module and the fluid can be improved.

In summary, the contacting of the at least one PTC thermistor element in the PTC heating module according to the invention is significantly simplified. The contacting of the at least one PTC thermistor element usually involving major technical expenditure is limited to a fixing of the respective contact element to the respective insulating board. Because of this, the production effort and the production costs can be reduced.

The invention also relates to a method for producing the PTC heating module described above. When producing the PTC heating module, the respective contacting tracks are fixed to the one insulating board and the respective contact elements to the respective contacting tracks on the one insulating board. This can be preferably effected by soldering or gluing. The at least one PTC thermistor element is fixed with the one main side to the one insulating board between the respective contact elements. Here, the contact elements are electrically contacted with the at least one PTC thermistor element on the respective lateral surfaces. The other insulating board is fixed to the other main surface of the at least one PTC thermistor element and the at least one PTC thermistor element and the insulating boards lying against the same are arranged in the housing of the PTC heating module.

In the method according to the invention, an installation space that is available for the contacting is not limited by the thickness of the at least one PTC thermistor element when fixing the respective contact elements to the respective contact tracks. In this advantageous manner, the expenditure for the usually technically elaborate contacting of the at least one PTC thermistor element can be significantly reduced.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

### BRIEF DESCRIPTION OF THE DRAWINGS

Preferred exemplary embodiments of the invention are shown in the drawings and are explained in more detail in the following description, wherein same reference numbers relate to same or similar or functionally same components.

It shows, in each case schematically

FIG. 1 a sectional view of a PTC heating module according to the invention in a first embodiment;

FIG. 2 a plan view of individual PTC thermistor elements in the PTC heating module shown in FIG. 1;

FIG. 3 an exploded view of the PTC heating module shown in FIG. 1;

FIG. 4 a sectional view of a PTC heating module according to the invention in a second embodiment;

FIG. 5 a plan view of individual PTC thermistor elements in the PTC heating module shown in FIG. 4;

FIG. 6 an exploded view of the PTC heating module shown in FIG. 4.

### DETAILED DESCRIPTION

FIG. 1 shows a sectional view of a PTC heating module 1 according to the invention in a first embodiment. The PTC heating module 1 comprises multiple—however only one visible here—cuboid PTC thermistor elements 2 each with two main surfaces 3a and 3b and each with two lateral surfaces 4a and 4b. The main surfaces 3a and 3b are arranged located opposite one another and connected to one another via the lateral surfaces 4a and 4b arranged located opposite one another. On the main surfaces 3a and 3b of the respective PTC thermistor element 2, a for example ceramic insulating board 5a and 5b each is arranged lying against the same, which electrically insulates the respective PTC thermistor element 2 from a housing 6 and connects the same to the housing 6 in a heat-transferring manner.

The heat exchanged between the PTC thermistor element 2 and a fluid—for example air—surrounding the PTC heating module 1 takes place on the main surfaces 3a and 3b of the respective PTC thermistor element 2 via the respective insulating boards 5a and 5b and via the housing 6. In this way, the heat generated in the respective PTC thermistor element 2 can be discharged to the fluid to be heated. The PTC heating module 1, furthermore, comprises rib structures 6a and 6b which lie against the housing 6 in a heat-transferring manner. The rib structures 6a and 6b are arranged located opposite the respective main surfaces 3a and 3b of the respective PTC thermistor element 2 and enlarged a heat-emitting surface of the housing 6 to be contacted with the fluid to be heated. The housing 6 and the rib structure 6a and 6b can be metallic, for example made of aluminium, in order to intensify the heat exchange between the fluid to be heated and the respective PTC thermistor element 2.

The respective PTC thermistor element 2 is electrically contacted to the outside on its lateral surfaces 4a and 4b via a contact element 7a and 7b lying against the respective lateral surface 4a and 4b in each case. The respective contact element 7a and 7b in this case is electroconductively fixed on the one side on the respective lateral surface 4a and 4b of the respective PTC thermistor element 2 and on the other side on a contacting track 8a and 8b. The respective contracting track 8a and 8b in this case is arranged on the insulating board 5a and in this first embodiment of the PTC heating module 1 an electroconductive solder layer 14 or an electroconductive adhesive layer 15. Accordingly, the respective contact element 7a and 7b is soldered or glued to the respective contacting track 8a and 8b. The respective PTC thermistor element 2 is thus electrically contactable to a negative terminal and to a positive terminal by the one contact element 7a or 7b and via the other contact element 7b or 7a respectively. To this end, an external voltage can be applied to the respective contacting track 8a and 8b and thus to the respective PTC thermistor element 2 and heat generated in the respective PTC thermistor element 2.

In the first embodiment of the PTC heating module 1 shown here, the respective contact element 7a and 7b is a C-shaped metal element 9a and 9b. The respective C-shaped metal element 9a and 9b is electroconductive and resilient by way of its shape so that the respective PTC thermistor element 2 remains mechanically stable and securely contacted even in the case of a major heat expansion of the individual components in the PTC heating module 1, such as for example of the housing 6 or of the insulating boards 5a and 5b. Furthermore, the contacting of the respective PTC thermistor element 2 and the overall construction of the PTC heating module 1 is significantly simplified by the respective contacting track 8a and 8b on the insulating board.

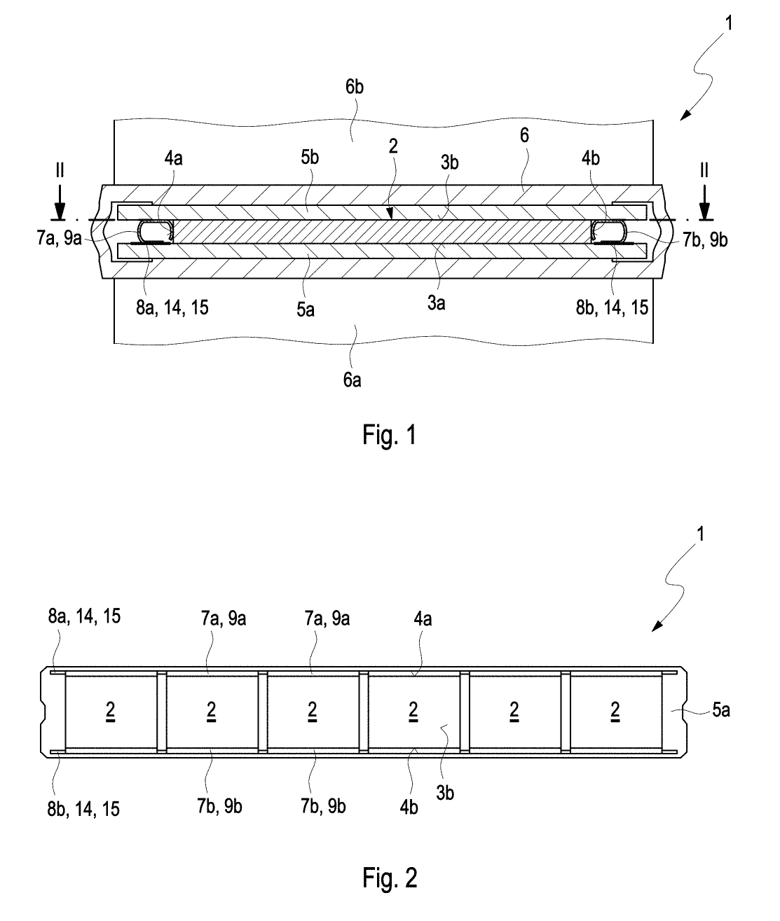

FIG. 2 shows a plan view of the individual PTC thermistor elements 2 of the PTC heating module 1 in the first embodiment. In the PTC heating module 1, a total of six PTC thermistor elements 2 are arranged on the insulating board 5a next to one another and electrically contactable with one another and to the outside via the respective joint contacting track 8a and 8b. The respective contact elements 7a and 7b are fixed to the respective contacting track 8a and 8b in a firmly bonded manner. In this first embodiment of the PTC heating module, the contact element 7a and 7b are the C-shaped metal elements 9a and 9b, which are soldered or glued to the contacting track 8a and 8b in the form of the electroconductive solder layer 14 or of the electroconductive adhesive layer 15.

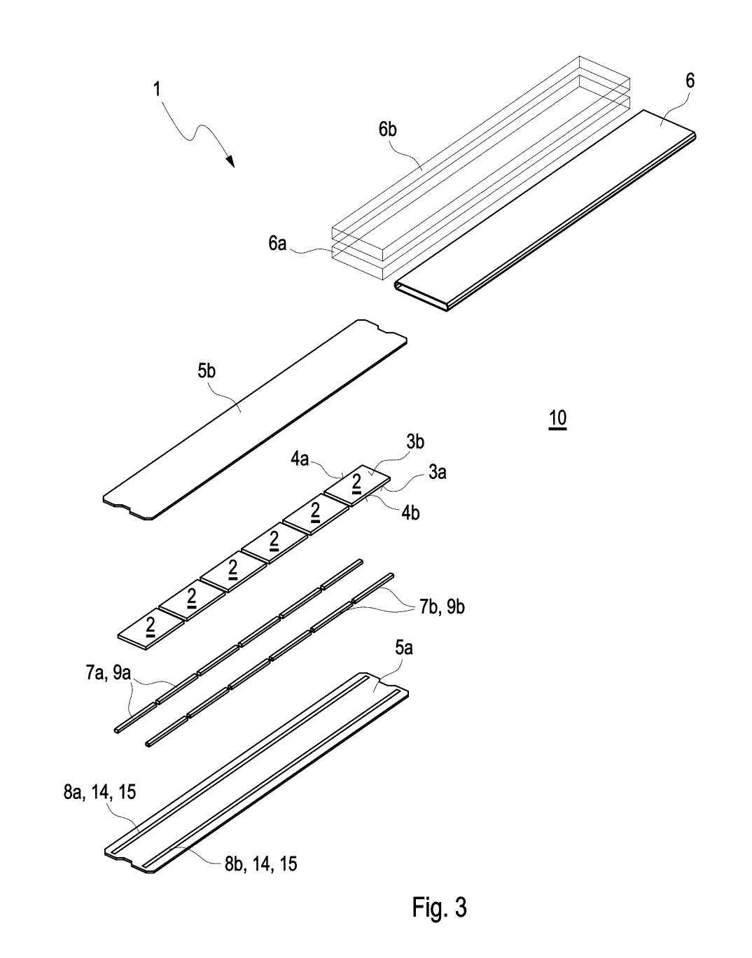

FIG. 3 shows an exploded view of the PTC heating module 1 in the first embodiment. In a method 10 according to the invention, the respective contacting tracks 8a and 8b are fixed in the form of the electroconductive solder layer 14 or the electroconductive adhesive layer 15 and the C-shaped metal elements 9a and 9b are soldered or glued to the respective contacting track 8a and 8b. The respective contacting track 8a and 8b is arranged on the insulating board 5a so that an installation space that is available for the contacting is not limited by the thickness of the PTC thermistor elements 2 in the PTC heating module 1. In this advantageous manner, the expenditure for the usually technically elaborate contacting of the PTC thermistor elements 2 can be significantly reduced. The PTC thermistor elements 2 are fixed with the main side 3a on the insulating board 5a between the respective metal elements 9a and 9b. Here, the metal elements 9a and 9b are electrically contacted with the PTC thermistor elements 2 on the respective lateral surfaces 4a and 4b. Following this, the other insulating board 5b can be fixed to the main surface 3b of the PTC thermistor elements 2 and the PTC thermistor elements 2 and the adjacent insulating boards 5a and 5b can be arranged in the housing 6 of the PTC heating module 1. Here, the respective rib structure 6a and 6b can be fixed to the housing 6 before or after the arranging of the PTC thermistor elements 2 and the adjacent insulating boards 5a and 5b in the housing 6.

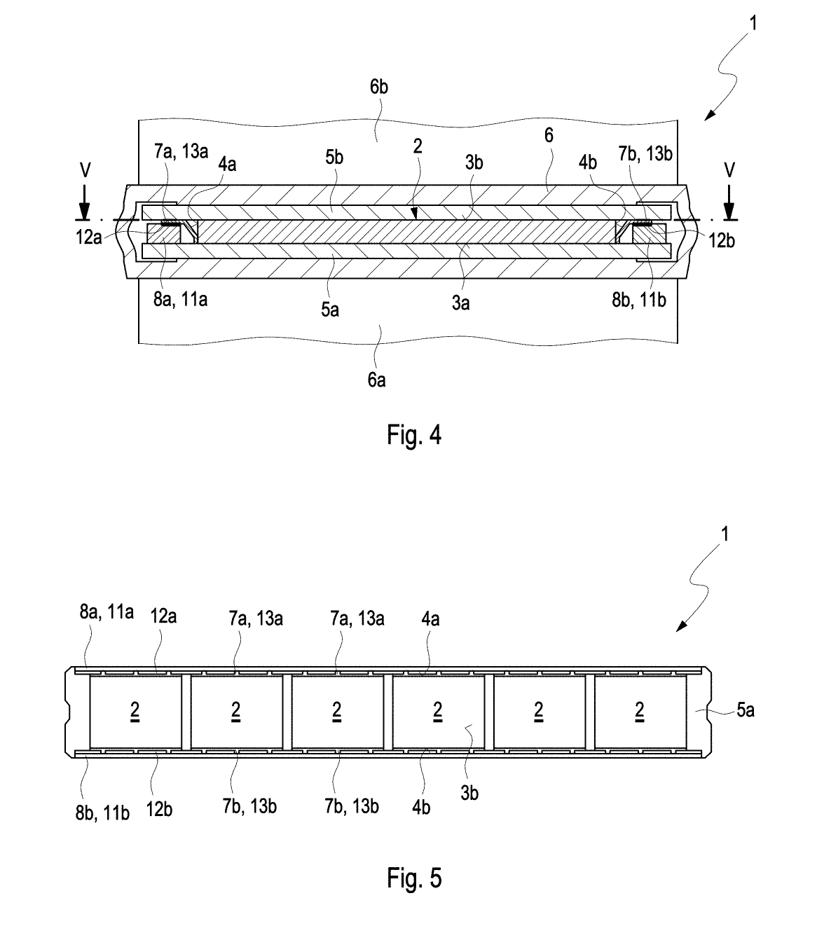

FIG. 4 shows a sectional view of the PTC heating module 1 according to the invention in a second embodiment. In the following, the differences between the first embodiment and the second embodiment of the PTC heating module 1 according to the invention are discussed separately. Otherwise, the construction of the PTC heating module 1 in the second embodiment corresponds to the construction of the PTC heating module 1 in the first embodiment. In the second embodiment of the PTC heating module 1, the respective contacting track 8a and 8b is formed in each case by an elongated circuit board 11a and 11b each with a conductor 12a and 12b. The respective circuit board 11a and 11b is fixed on the insulating board 5a in a firmly bonded manner, preferably by soldering or gluing. The respective contact element 7a and 7b in this second embodiment of the PTC heating module 1 is an L-shaped metal element 13a and 13b which is fixed to the conductor 12a and 12b of the respective circuit board 11a and 11b in a firmly bonded manner preferably by soldering or gluing.

FIG. 5 shows a top view of the individual PTC thermistor elements 2 of the PTC heating module 1 in the second embodiment. In the PTC heating module 1 a total of six PTC thermistor elements 2 are arranged on the insulating board 5a next to one another and electrically contacted with one another and to the outside via the respective joint contacting track 8a and b. On the respective contacting track 8a and 8b, the respective contact elements 7a and 7b are fixed in a firmly bonded manner. In this second embodiment of the PTC heating module, the contact elements 7a and 7b are the L-shaped metal elements 13a and 13b, which are soldered or glued to the respective contacting track 8a and 8b in the form of the circuit board 11a and 11b with the conductor 12a and 12b.

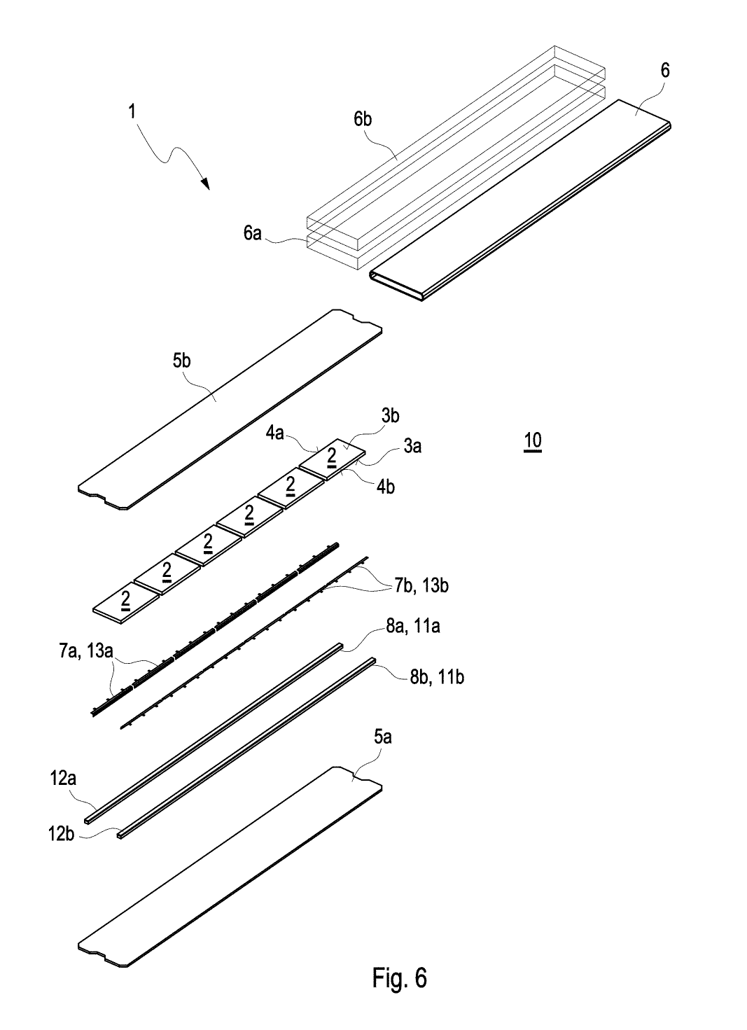

FIG. 6 shows an exploded view of the PTC heating module 1 in the second embodiment. In the method 10 according to the invention, the circuit boards 11a and 11b are fixed on the insulating board 5a in a firmly bonded manner, preferably by soldering or gluing and the L-shaped metal elements 13a and 13b are soldered or glued to the respective conductor 12a and 12b of the respective circuit board 11a and 11b. The respective circuit board 11a and 11b in this case is arranged on the insulating board 5a and an installation space that is available for the contacting is not limited by the thickness of the PTC thermistor elements 2 in the PTC heating module 1. Because of this, the effort for the usually technically elaborate contacting of the PTC thermistor elements 2 can be significantly reduced. The PTC thermistor elements 2 are fixed with the main side 3a to the insulating board 5a between the respective metal elements 13a and 13b and electrically contacted with these on the respective lateral surfaces 4a and 4b. The other insulating board 5b is fixed to the main surface 3b of the PTC thermistor elements 2 and the PTC thermistor elements 2 and the adjacent insulating boards 5a and 5b are arranged in the housing 6 of the PTC heating module 1. The respective rib structure 6a and 6b in this case can be fixed to the housing 6 before or after the arranging of the PTC thermistor elements 2 and the adjacent insulating boards 5a and 5b in the housing 6.

In summary, the contacting of the respective PTC thermistor element 2 in the PTC heating module 1 according to the invention and the overall construction of the PTC heating module 1 according to the invention is significantly simplified. The contacting of the at least one PTC thermistor element 2 usually involving major technical expenditure is limited by the method 10 according to the invention to a fixing of the respective contact element 7a and 7b on the contacting track 8a and 8b on the respective insulating board 5a. Here, an installation space that is available for the contacting is not limited by the thickness of the PTC thermistor elements 2 in the PTC heating module 1. Because of this, the production effort and also the production costs can be reduced.

1. A PTC heating module for heating a fluid, comprising:
at least one cuboid PTC thermistor element with two main surfaces located opposite one another, which are connected to one another via two lateral surfaces located opposite one another;
two contact elements each lying against a respective one of the two lateral surfaces, and via which the at least one cuboid PTC thermistor element is electrically contactable;
a housing in which the at least one cuboid PTC thermistor element and the two contact elements are arranged; and
two insulating boards in each lying against a respective one of the two main surfaces of the at least one cuboid PTC thermistor element in a heat-transferring manner, each insulating board electrically insulating the at least one cuboid PTC thermistor element from the housing and connecting the at least one cuboid PTC thermistor element to the housing in a heat-transferring manner;
wherein each contact element is electroconductively fixed on one side on the respective one of the two lateral surfaces and on another side on a respective one of two contacting tracks, wherein each contacting track is arranged on a respective one of the insulating boards.

2. The PTC heating module according to claim 1, wherein each contacting track is formed as one of an electroconductive solder layer or an electroconductive adhesive layer, by way of which the respective contact element is soldered or glued on the respective one of the insulating boards.

3. The PTC heating module according to claim 1, wherein each contacting track is formed as a conductor that is fixed to the respective one of the insulating boards in a firmly bonded manner and on which a respective one of the contact elements is fixed in a firmly bonded manner.

4. The PTC heating module according to claim 1, wherein each contacting track is formed as a circuit board with at least one conductor, wherein the circuit board is fixed to the respective one of the insulating boards and a respective one of the contact elements is fixed to the at least one conductor in a firmly bonded manner.

5. The PTC heating module according to claim 4, wherein the at least one conductor is fixed on the circuit board in a firmly bonded manner.

6. The PTC heating module according to claim 1, wherein each insulating board is ceramic.

7. The PTC heating module according to claim 1, wherein each contact element is formed as a resilient S- or C- or L- or O-shaped metal element.

8. The PTC heating module according to claim 1, further comprising at least one rib structure for the discharge of heat, which lies against the housing in a heat-transferring manner and is located opposite a respective one of the two main surfaces of the at least one PTC thermistor element.

9. The PTC heating module according to claim 1, wherein the housing is metallic.

10. The PTC heating module according to claim 1, wherein the at least one PTC thermistor element is electrically contactable by one of the contact elements with a negative terminal and the other of the contact elements with a positive terminal.

11. A method for producing a PTC heating module, comprising:
fixing each of two contacting tracks to a respective one of two insulating boards;
fixing each of two contact elements to a respective one of the two contacting tracks of the respective one of the two insulating boards;
at least one PTC thermistor element with one of two main surfaces to one of the two insulating boards between the two contact elements, wherein each contact element electrically contacts the at least one PTC thermistor element on a respective one of two lateral surfaces of the at least one PTC thermistor element that are arranged opposite one another and connect the two main surfaces;
fixing the other of the two insulating boards to the other of the two main surfaces of the at least one PTC thermistor element that is arranged opposite the one of the two main surfaces; and
arranging the at least one PTC thermistor element and the two insulating boards in a housing.

12. The method according to claim 11, wherein each contacting track is an electroconductive solder layer or an electroconductive adhesive layer.

13. The method according to claim 11, wherein each contacting track is a conductor that is fixed to the respective one of the insulating boards in a firmly bonded manner.

14. The method according to claim 11, wherein each contacting track is a circuit board with at least one conductor, wherein a respective one of the contact elements is fixed to the at least one conductor in a firmly bonded manner.

15. The method according to claim 14, wherein the at least one conductor is fixed on the circuit board in a firmly bonded manner.

16. The method according to claim 11, wherein each insulating board is ceramic.

17. The method according to claim 11, wherein each contact element is a resilient S- or C- or L- or O-shaped metal element.

18. The method according to claim 11, further comprising laying at least one rib structure against the housing in a heat-transferring manner opposite a respective one of the two main surfaces of the at least one PTC thermistor element.

19. The method according to claim 11, wherein the housing is metallic.

20. A PTC heating module for heating a fluid, comprising:
at least one cuboid PTC thermistor element with two main surfaces located opposite one another, which are connected to one another via two lateral surfaces arranged located opposite one another;
two contact elements each lying against a respective one of the two lateral surfaces and via which the at least one cuboid PTC thermistor element is electrically contactable;
a housing in which the at least one cuboid PTC thermistor element and the two contact elements are arranged;
two insulating boards each lying against a respective one of the two main surfaces of the at least one cuboid PTC thermistor element in a heat-transferring manner, each insulating board electrically insulating the at least one cuboid PTC thermistor element from the housing and connecting the at least one cuboid PTC thermistor element to the housing in a heat-transferring manner; and
at least one rib structure for the discharge of heat, which lies against the housing in a heat-transferring manner and is located opposite a respective one of the two main surfaces of the at least one PTC thermistor element;
wherein each contact element is electroconductively fixed on one side on the respective one of the two lateral surfaces and on another side on a respective one of two contacting tracks, wherein each contacting track is arranged on a respective one of the insulating boards; and
wherein each contacting track is a circuit board with at least one conductor, wherein a respective one of the contact elements is fixed to the at least one conductor in a firmly bonded manner, and the at least one conductor is fixed on the circuit board in a firmly bonded manner.
